(19) United States
(12) Patent Application Publication
(10) Pub. No.: US 2015/0161449 A1
(43) Pub. Date: Jun. 11, 2015

(54) SYSTEM AND METHOD FOR THE USE OF MULTIPLE CAMERAS FOR VIDEO SURVEILLANCE

(71) Applicant: Systems Engineering Technologies Corporation, Alexandria, VA (US)

(72) Inventors: Luis Gil Armendariz, Stafford, VA (US); Jeff JERRELL, Stafford, VA (US); Aaron Luis Armendariz, Alexandria, VA (US); Jose A. DIAZ, Alexandria, VA (US)

(21) Appl. No.: 14/568,067

(22) Filed: Dec. 11, 2014

Related U.S. Application Data
(60) Provisional application No. 61/914,767, filed on Dec. 11, 2013.

(51) Int. Cl. G06K 9/00; H04N 5/77; G11B 27/30; H04N 7/18

(52) U.S. Cl. CPC G06K 9/00744; H04N 7/181; H04N 5/77; G06K 9/00771; G11B 27/3027; G06K 2009/00738

(57) ABSTRACT

A multiple-camera video surveillance system includes a first camera configured to stream compressed video and a second camera configured to take high-resolution snap shots, the first and second camera having overlapping views of a single location. An electronic storage medium stores compressed live video and/or high-resolution snap shots taken by the cameras. A processing device is configured to store data from the first and second camera in the electronic storage medium and assign datestamps to the stored data. A viewing station remote from the plurality of cameras is configured to access compressed video from the first camera to identify an event at the one location, determine a time of the event based on datestamps associated with the accessed data from the first camera, retrieve high-resolution snap shots from the second camera from near the time of the event, and analyze the retrieved high-resolution snap shots from the second camera by zooming in on areas of the high-resolution snap shots and identifying objects in the zoomed-in areas that are not identifiable in the compressed video from the first camera.

This application claims the benefit of U.S. Provisional Application No. 61/914,767, filed Dec. 11, 2013, which is hereby incorporated by reference in its entirety.

### TECHNICAL FIELD

This disclosure relates generally to information technology. More specifically, this disclosure relates to transmission and analysis of video signals via the transmission of the video images to a processing computer using an IP network.

### BACKGROUND

Video Surveillance has a number of requirements that directly oppose each other. The ideal arrangement for video surveillance is to have (1) the maximum resolution on all frames in real time, (2) ability to view the video surveillance at some viewing station(s), (3) an un-restricted amount of bandwidth to transfer the video images to the viewing stations, (4) recording of the high resolution images in a record media with no distortion, (5) connection via numerous kinds of IP transports, (6) a small, low-consumption system allowing for the use of portable power and (7) the ability to use identification software programs such as license plate readers and face identification to provide near real-time analysis.

With the installation of video surveillance cameras in numerous cities in the United States and in cities around the world, high resolution video will be in great demand. Currently the installations of these cameras are generally in fixed locations, mobile command vehicles and helicopters. In the near future these video surveillance cameras will be mounted on drones. Drones will require small video packages with low power consumption.

Problems exist due to limitations in the transfer of video images to a video viewer. Cameras are being developed to allow for ever increasing resolution. Smart Phones have cameras with upward of 20 to 40 Mega Pixels per frame. In order to achieve continuous motion video, the common accepted frames per second is in the neighborhood of 15 frames per second. This would require (20MP×15FPS)=300 mega pixels per second or (300/8) 37.5 Megabytes per second. This amount of data transfer using common forms of wireless transmissions is not realistic. To resolve this lack of bandwidth, the current solution is to compress the video. Video algorithms/codecs such as H.264 will provide compression ratios of better than 100 to 1. However the tradeoff is resolution of the video. Accordingly, needs exist for improved methods and systems for video surveillance.

### SUMMARY

An ideal surveillance solution provides both continuous video streaming and high resolution video frames. A new multiple camera video surveillance system and method allows for both video streaming and high resolution video frames. To achieve this requirement, multiple cameras may be used. These multiple cameras may be focused on the same area of interest. One camera may provide compressed video streaming and the second camera may take high resolution uncompressed video frames. When an incident occurs, the event is captured in the streaming video. All recordings are time stamped, thus it is known when the incident occurred. A user may then connect to the video images which have been taken by the high resolution camera. These high resolution frames may then be downloaded and analyzed. Having high resolution frames allows for any portion of the frame to be “zoomed in” while retaining a good quality of the sectionalized image.

Examples of where this is highly useful include law enforcement video surveillance. The multiple camera system is focused in the area of interest. When an incident or event occurs, the streaming audio may be used to determine when the event occurred. The high resolution snap shots may then be downloaded and small features may be blown up for purposes such as face recognition, detection of transfer of illegal items, recognition of arms, reading of license plates, etc.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a schematic of a system for video surveillance using multiple cameras, in an embodiment.

FIG. 2 is a diagram depicting a system for video surveillance using multiple cameras, in an embodiment.

FIG. 3 is a flowchart illustrating a multiple camera video surveillance method, in an embodiment.

FIG. 4 is a flowchart illustrating an image analysis method, in an embodiment.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Embodiments of the present invention can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit (“CPU”) or processor, at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, etc.), or the like. In embodiments of the invention, the computer has access to at least one database over the network.

ROM, RAM, and HD are computer memories for storing computer-executable instructions executable by the CPU or capable of being complied or interpreted to be executable by the CPU. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of C++, Java, JavaScript, HTML, or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

It will be understood for purposes of this disclosure that a module is one or more computer processes, computing devices or both, configured to perform one or more functions. A module may present one or more interfaces which can be utilized to access these functions. Such interfaces include APIs, web services interfaces presented for a web services, remote procedure calls, remote method invocation, etc.

Embodiments disclosed herein provide systems and methods for video surveillance using multiple cameras.

A new system for providing both real-time video streaming and post high resolution analysis allows law enforcement and other public safety officials the opportunity to detect real-time events and analyze high resolution images thereof. The high resolution images provide for the use of facial recognition algorithms, reading of license plates, detection of transfer of illegal items, finding missing children, and other events being monitored and recorded. Multiple cameras may be used, at least one for streaming video and at least one a high resolution camera for taking snap shots at pre-defined times. The system may include at least two processors/computers interconnected by an IP network. A network over which the system operates may be independent of any other networks. The system may include a viewing station in the nature of a computer, mobile phone or other technical equipment that can receive images. The system may be used in law enforcement and public safety applications. A storage system may be installed in the multiple camera system to record streaming video and/or high-resolution images. Control processors may be installed at the location of the multiple cameras and/or at the location of the remote viewing stations. The system may include a portable battery system allowing for installation in locations where power is not available. The battery system may be rechargeable, allowing for energy sources such as solar or wind power. The system may allow for connection using WIFI. The system may allow for connection using 3G/4G/LTE and/or other commercial data connections. The system may allow for direct connection using such IP transports as USB, Ethernet and/or others.

A new method for observation of an incident site may be performed by following the steps of (a) viewing streaming video, either in real time or by post playing recorded video, (b) identifying events of interest, (c) displaying high resolution images on a viewing display, (d) zooming to multiple areas of interest, and (e) performing analysis of the sectionalized zoomed images.

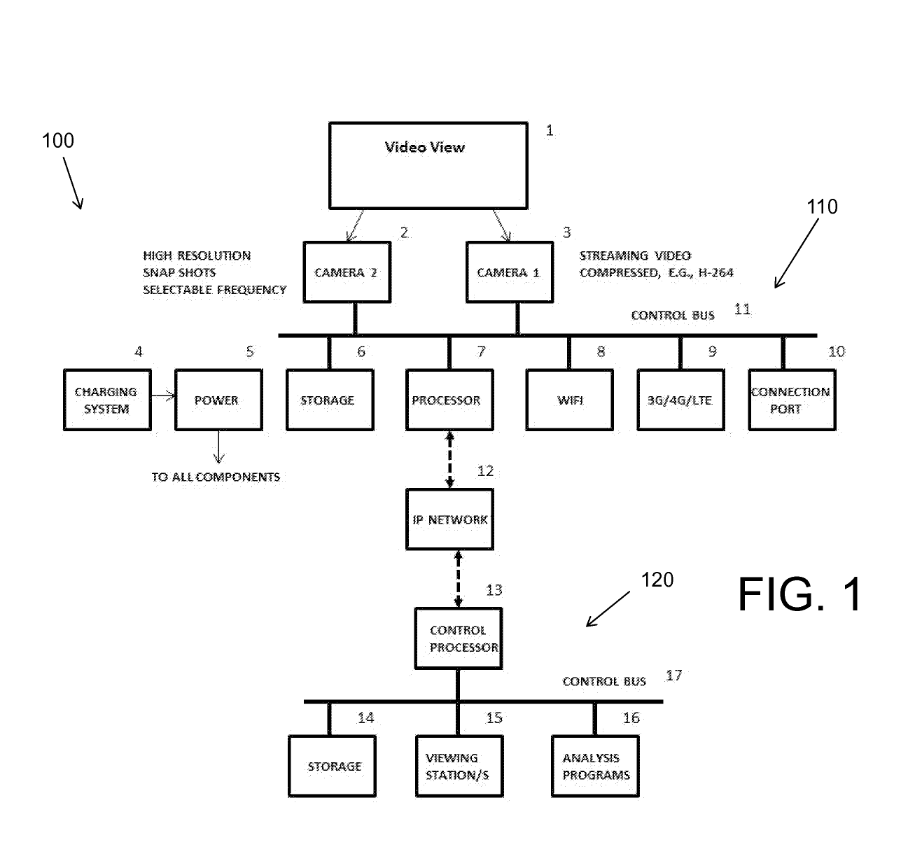

FIG. 1 is a schematic of a system for video surveillance 100 using multiple cameras, in an embodiment. The video surveillance system 100 includes camera system 110 connected by IP Network 12 to remote site 120. Video View 1 is any selected area where there is a need to monitor activities. These activities need to be monitored on a 24×7 basis and it is important that continuous video be available for real time viewing and recording. There may be motion sensors in the Video View 1 area that need to be activated to allow for alerts to indicate movement, such as cars moving in the Video View 1 area or persons walking in the Video View 1 area of interest. In embodiments these motion sensors may activate the video surveillance system, which may otherwise be dormant to conserve power, computer storage, bandwidth, etc.

Camera 2 is a very high resolution camera, e.g., 40 Mega Pixels or higher. This camera takes snap shots at intervals as selected by the user using e.g. a computer interface such as a GUI on viewing station 15. Snap shots may be un-compressed and may be stored in a local storage system 6. All snap shots may be time stamped in order to retrieve the images as required. These high resolution images allow the user to “zoom in” to any section of the image while retaining viewing quality. For example, an image taken at X time shows a car and a person driving the car. With the high resolution image, the user may be able to zoom in and see the numbers of the license plate of the car and clearly view the face of the person of interest. The high resolution of the image may allow for facial recognition software analysis.

Second camera 3 may provide for real time streaming of the video. The video may be compressed (e.g., H-264) to allow for transmission over an IP connection 12 using e.g. WIFI, or 3G/4G/LTE data services of commercial carriers. The video from second camera 3 may also be stored in a local storage system 6. This local storage allows for the retrieval of the video should there not be a real time connection to the camera 3.

A charging system 4 is connected to the batteries of the system (e.g. power 5), which may power the camera system 110. The charging system 4 may utilize solar or wind power. Power 5 may be provided as either 115VAC or 12 VDC. With the 12 VDC a battery or batteries may be used to power the camera system. All components in the system are low power consumption, thus batteries can be used to allow operation in remote areas or to allow for quick installation when circumstances require video for investigative purposes.

A storage system 6 is included in the remote camera system 110. Both snap shots and streaming video may be recorded. All recordings may be time stamped and a database may allow for ease of retrieval from the control processor 13. Storage system 6 may be a device that stores data received from camera system 110. Storage system 6 may include, but is not limited to a hard disc drive, an optical disc drive, and/or a flash memory drive. In embodiments, storage system 6 may comprise non-transitory storage media that electronically stores data associated with camera system 110. Storage system 6 may be configured to store data and media and corresponding time stamps received from camera system 110, such as media at the location of camera system 110 that may be associated with an emergency.

A processor 7 such as a single board computer is used to control all of the required functions of the cameras.

The system includes a WIFI circuit 8 for creating a local WIFI network for connecting to the camera system from the immediate area. For example, the camera system is installed on a telephone pole. The users may drive to the vicinity of the camera system and connect to the streaming video or download the high resolution snap shots by logging in to the WIFI network The WIFI network 8 may be encrypted and may be password protected with the SSID not transmitting.

3G/4G/LTE network connection 9 is included in the camera system for connectivity to the local commercial data services. This IP connect 9 may allow for real time monitoring of the streaming video over the data connection. Should an incident require analysis of the video, the user may stream selected snap shots during the time of the incident. These high resolution snap shots may be downloaded at varying times depending on the bandwidth available thru the IP network connection 12.

The camera system 110 has a physical connection port 10 such as a USB and/or an Ethernet connection. All items in the camera system 110 are controlled using a control bus 11.

The IP network 12 allows for connection from the remote viewing station 15 to the camera system. The IP network 12 can be WIFI, 3G/4G/LTE (e.g. through 3G/4G/LTE connection 9), LAN Cable or fiber, or another wired or wireless network. It will be understood that IP network 12 may be a combination of multiple different kinds of wired or wireless networks. It will be further understood that IP Network 12 may be configured to communicate packetized and/or encrypted data to devices within surveillance system 100.

A control processor/computer 13 may have a software application to allow the user to use a Graphical User Interface (GUI) to perform all required operational functions, such as viewing of multiple cameras systems, receipt of alerts, playback of recorded video, viewing real time video, zooming to selected areas of the video image, performing analysis programs (license plate reader, face recognition etc.), etc. Control processor 13 may include memory, e.g., read only memory (ROM) and random access memory (RAM), storing processor-executable instructions, and one or more processors that execute the processor-executable instructions. In embodiments where control processor 13 includes two or more processors, the processors may operate in a parallel or distributed manner. Control processor 13 may execute an operating system of surveillance system 100 and/or software associated with other elements of surveillance system 100, such as analysis programs 15, received data and media associated with a location from cameras 2,3, etc.

At the remote site 120, a storage system 14 allows for the recording and play back of all video. Storage system 14 may be a device that stores data received from camera system 110, and/or data computed by control processor 13. Storage system 14 may include, but is not limited to a hard disc drive, an optical disc drive, and/or a flash memory drive. In embodiments, storage system 14 may comprise non-transitory storage media that electronically stores data associated with camera system 110, viewing station(s) 15, etc. Storage system 14 may be configured to store data and media and corresponding time stamps received from camera system 110, such as media at the location of camera system 110 that may be associated with an emergency.

Viewing Station(s) 15 allow users to view real time and/or recorded video. In alternative embodiments it may be connected with a plurality of remote camera systems 110, via one or a plurality of networks 12.

Analysis programs 16 for analyzing the video and/or high resolution images (e.g. facial recognition programs, character recognition programs, etc.) may be installed in the control computer 13 and/or in the viewing stations 15.

A control bus 17 connects the IP network 12, control processor/computer 13, viewing stations 15 and/or any user-provided processors or computers.

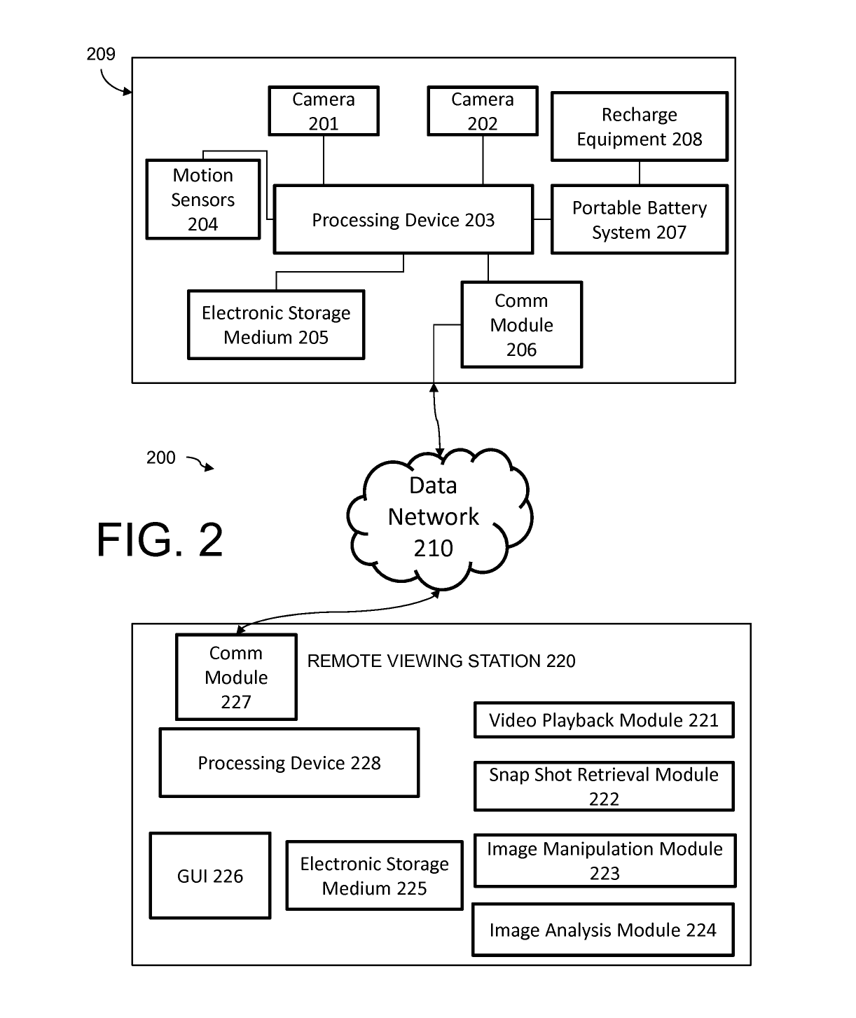

FIG. 2 is a diagram depicting a network topology 200 for a video surveillance system using multiple cameras, in an embodiment.

The network topology 100 includes one or more camera systems 209 and a remote viewing station 220 connected to each other over a data network 210.

Data network 210 may be a wired or wireless network such as the Internet, an intranet, a LAN, a WAN, a virtual private network (VPN), a cellular network, radio network, telephone network, and/or another type of network. It will be understood that network 210 may be a combination of multiple different kinds of wired or wireless networks. It will be further understood that network 210 may be configured to communicate packetized and/or encrypted data to devices within network topology 200. Data network 210 may be the same as or similar to IP Network 12 of FIG. 1.

Camera system 209 may be any type of computing device with a hardware processor that is configured to process instructions and connect to network 210, or one or more portions of network 210. In one embodiment, camera system 209 may include first camera 201, second camera 202, processing device 203, motion sensors 204, electronic storage medium 205, communications module 205, portable battery system 207, and recharge equipment 208.

Processing device 203 may include memory, e.g., read only memory (ROM) and random access memory (RAM), storing processor-executable instructions, and one or more processors that execute the processor-executable instructions. In embodiments where processing device 203 includes two or more processors, the processors may operate in a parallel or distributed manner. Processing device 203 may execute an operating system of camera system 209 or software associated with other elements of alert system 209, such as received data and media associated with a location from cameras 201, 202.

Communications module 206 may be a hardware device configured to communicate with another device, e.g., remote viewing station 220 over network 210 or otherwise. Communications module 206 may include one or more wireless transceivers for performing wireless communication and/or one or more communication ports for performing wired communication. In embodiments, communications module 112 may be configured to packetize data obtained from cameras 201, 202, and communicate the packetized data over network 210 according to any known protocol, which in embodiments may be an encrypted protocol. Communications module 206 may contain necessary hardware and software for communication by WIFI, wired Internet, 3G/4G/LTE, and/or USB or other physical cable.

Cameras 201, 202 are hardware devices configured to record video, images and/or audio at a location, having overlapping views. In embodiments, cameras 201, 202 may be positioned in a location, such as a home, school, church, or any other location where surveillance is desired, and a location of each camera 201, 202 may be stored within electronic storage medium 205. In embodiments, each camera may be configured to record still images and/or videos, and a video resolution and/or the number of frames per second and/or frequency of still shots obtained by the camera may be configurable. Processing device 203 or cameras 201, 202 may generate datestamps associated with a data and time that each image is obtained. In embodiments, the cameras 201, 202 may be positioned such that they have substantially completely overlapping views, e.g. directly adjacent to one another.

Electronic storage medium 205 may be a device that stores data generated or received by camera system 209. Electronic storage medium 205 may include, but is not limited to a hard disc drive, an optical disc drive, and/or a flash memory drive. In embodiments, electronic storage medium 205 may comprise non-transitory storage media that electronically stores data and media associated with camera system 209, such as data and media obtained from cameras 201, 202. Electronic storage medium 205 may store a globally unique identifier for camera system 209, and a location of the camera system 209. The location of alert system 209 may be determined via real-time located system signals (RTLS), WiFi signals, GPS, Bluetooth, or any other mechanism to determine a location.

Electronic storage medium 205 may also be configured to store media, data, and other information obtained by cameras 201, 202. Electronic storage medium 205 may also be configured to store datestamp corresponding to a date and time that the media, data, and/or other information is obtained by cameras 201, 202.

Portable battery system 207 may be used to power cameras 201, 202 and/or the entire camera system 209. Recharge equipment 208 is connected to the portable battery system 207 and may utilize solar or wind power.

Motion sensors 204 may be triggered by movement in the location of cameras 201, 202 and may activate cameras 201, 202 such that they begin capturing video and images of the location.

Remote viewing station 220 may be a computing device that is configured to communicate data over network 210, and may be communicatively coupled to camera system(s) 209. Remote viewing station 220 may include processing device 228, communications module 227, electronic storage medium 225, GUI 226, video playback module 221, snap shot retrieval module 222, image manipulation module 223, and image analysis module 224.

Processing device 228 may include memory, e.g., read only memory (ROM) and random access memory (RAM), storing processor-executable instructions and one or more processors that execute the processor-executable instructions. In embodiments where processing device 228 includes two or more processors, the processors may operate in a parallel or distributed manner. Processing device 228 may execute an operating system of remote viewing station 220 and/or software associated with other elements of remote viewing station 220.

Communications module 227 may be a hardware device configured to communicate with another device, e.g., camera system(s) 209 via network 210. Communications module 227 may include one or more wireless transceivers for performing wireless communication and/or one or more communication ports for performing wired communication. In embodiments, communications module 227 may be configured to packetize data, which may be encrypted, and communicated over network 210 according to any known protocol. Communications module 227 may be configured to transmit audio data, push to talk (PTT) audio data, video data, and other data over any known protocol.

Electronic storage medium 225 may be a device that stores data received from camera system 209, GUI 226, and/or data computed by processing device 228. Electronic storage medium 225 may include, but is not limited to a hard disc drive, an optical disc drive, and/or a flash memory drive. In embodiments electronic storage medium 225 may comprise non-transitory storage media that electronically stores data associated with camera system 209, GUI 226, and/or data computed by processing device 228. Electronic storage medium 225 may be configured to store data and media and corresponding datestamps received from camera system 209. Electronic storage medium 225 may also be configured to store pre-recorded media that may be presented to users on GUI 226.

GUI 226 may be a device that allows a user to interact with remote viewing station 220. While one GUI 226 is illustrated, the term “graphical user interface” may include, but is not limited to being, a touch screen, a physical keyboard, a mouse, a microphone, and/or a speaker. GUI 226 may include a display configured to present data or media received from camera system 110. A user may enter commands on GUI 128 to be presented with media and other information associated with camera system 209. In embodiments, the user may be required to input authorization data, such as a username and/or password, to be presented with the media and other information associated with the camera system.

A user may use GUI 226 to input instructions for cameras 201, 202 and camera system 209 generally via data network 210, for example to set the frequency at which camera 202 takes high-resolution still images.

Video playback module 221 is configured to play on the remote viewing station 220 videos recorded by cameras 201/202 for a user's viewing. A user may manually determine when an event is occurring in the video being displayed and determine the datestamp (date and time) at which that video was recorded. Snap shot retrieval module 222 is configured to retrieve and display desired still images, for example still images taken at the same time as the video was recorded where the event was captured. Image manipulation module 223 is configured to manipulate the retrieved high-resolution still images, for example by zooming in on areas of interest (as well as for example, panning, rotating, and other standard image manipulation operations). Image analysis module 224 is configured to process an image, area of an image, and particularly zoomed area of an image. The image analysis module may be configured, for example, to perform facial recognition analysis on a zoomed area of an image, optical character recognition on an area of an image appearing to contain alphanumeric characters, etc.

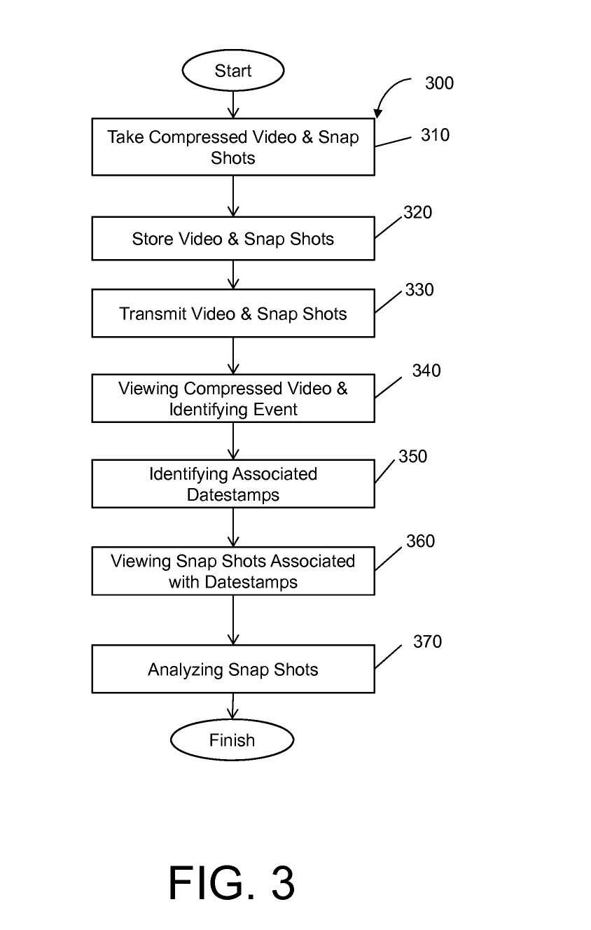

Turning now to FIG. 3, FIG. 3 depicts a method 300 for multiple camera surveillance. The steps of method 300 presented below are intended to be illustrative. In some embodiments, method 300 may be accomplished with one or more additional steps that are not described below, and/or without one or more of the steps described below. Additionally, the order in which the steps of method 300 are illustrated in FIG. 3 and described below is not intended to be limiting.

At step 310, compressed video is recorded from a first camera at a location and high-resolution snap shots are taken from a second camera at the location with an overlapping view. This action may be triggered by a motion sensor or according to programmed instructions, for example it may be performed continuously or according to a pre-programmed schedule. It may in an embodiment be carried out by sending instructions entered through GUI 226 from remote viewing station 220 via data network 210 to processing device 203.

At step 320, the compressed video and high-resolution snap shots are stored with associated datestamps, in an embodiment on electronic storage medium 205.

At step 330, the compressed video and high-resolution snap shots are transmitted to a remote location, in an embodiment to remote viewing station 220 via data network 210, for example in response to requests from snap shot retrieval module 222 and/or video playback module 221 or processing device 228.

At step 340, the compressed video is viewed at the remote location and an event at the location of the cameras is identified. In an embodiment the remote location is remote viewing station 220 and the compressed video is viewed using video playback module 221.

At step 350, datestamps (i.e. date and time) associated with compressed video of the event are identified. In this way, the time at which the event at the location of the cameras occurred is pinpointed. In an embodiment the datestamps are identified using video playback module 221.

At step 360, high-resolution snap shots associated with the identified datestamps are viewed. In an embodiment, the high-resolution snap shots are viewed using snap shot retrieval module 222.

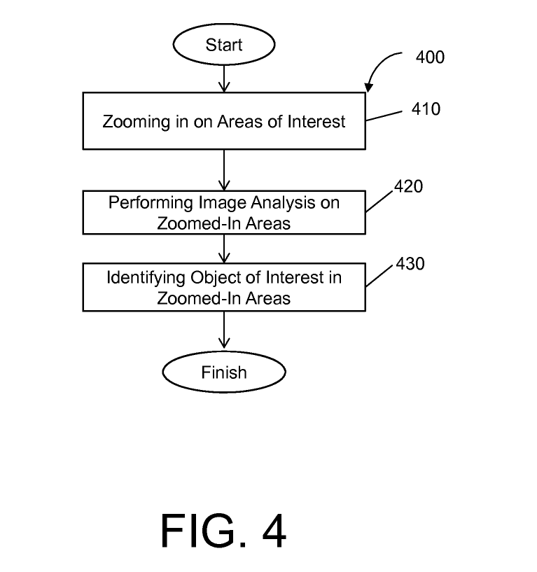

At step 370 the high-resolution snap shots associated with the identified datestamps are analyzed. This analysis may include zooming in on areas of interest in the high-resolution snap shots, running one or more image analysis programs on the zoomed-in area of interest and identifying objects in the zoomed-in areas that are not identifiable in the compressed video of the event, as described below with reference to FIG. 4. In an embodiment the analysis may be performed using at least image manipulation module 223 and image analysis module 224.

Turning now to FIG. 4, FIG. 4 is a flowchart illustrating an image analysis method, in an embodiment. The steps of method 400 presented below are intended to be illustrative. In some embodiments, method 400 may be accomplished with one or more additional steps that are not described below, and/or without one or more of the steps described below. Additionally, the order in which the steps of method 400 are illustrated in FIG. 4 and described below is not intended to be limiting.

At step 410, areas of interest in the high-resolution snap shots are zoomed in to increase their size for ease of analysis. In an embodiment, this zoom is performed by image manipulation module 223 and may be performed on multiple area simultaneously.

At step 420, image analysis is performed on the zoomed-in areas, for example a facial recognition program, optical character recognition program, etc. may be run on the areas. In an embodiment, this analysis is performed using image analysis module 224.

At step 430, objects in the zoomed-in areas that are not identifiable in the compressed video of the event are identified. In an embodiment this identification is carried out using image analysis module 224, for example a facial recognition program may generate a determination as to the identity of a person shown in the image, or the characters of a license plate in the image may be determined by an optical character recognition program.

In the foregoing specification, embodiments have been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It is also within the spirit and scope of the invention to implement in software programming or of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example, only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What I claim is:

1. A multiple-camera video surveillance system comprising:
a plurality of cameras at one location, comprising a first camera configured to stream compressed video and a second camera configured to take high-resolution snap shots, wherein the first and second camera have overlapping views;
an electronic storage medium for storing the compressed live video and/or high-resolution snap shots;
a processing device configured to store data from the first and second camera in the electronic storage medium and assign datestamps to the stored data;
a viewing station remote from the plurality of cameras and configured to access compressed video from the first camera to identify an event at the one location, determine a time of the event based on datestamps associated with the accessed data from the first camera, retrieve high-resolution snap shots from the second camera from near the time of the event, and analyze the retrieved high-resolution snap shots from the second camera by zooming in on areas of the high-resolution snap shots and identifying objects in the zoomed-in areas that are not identifiable in the compressed video from the first camera.

2. The system of claim 1, wherein the second camera is configured to take the high-resolution snap shots at a selectable frequency and the processing device is configured to set the selectable frequency of the second camera according to received camera configuration instructions.

3. The system of claim 1, further comprising one or more motion sensors at the one location, wherein the first camera and second camera are activated when the motion sensors are triggered.

4. The system of claim 1, wherein the viewing station is connected with the processing device over a data network.

5. The system of claim 4, wherein the data network operates independently of any other networks.

6. The system of claim 1, wherein the processing device controls operation of the first and second cameras.

7. The system of claim 1, further comprising a portable battery system configured to power the cameras and processing device, for installation in areas without access to electric power.

8. The system of claim 7, wherein the portable battery system is rechargeable, further comprising recharge equipment for recharging the portable battery system with wind and/or solar power.

9. The system of claim 1, wherein the viewing station comprises a video playback module, a high-resolution snap shot retrieval module, an image manipulation module, and an image analysis module.

10. A multiple-camera video-surveillance method, comprising:
recording compressed video from a first camera at a location and taking high-resolution snap shots from a second camera at the location with an overlapping view;
storing the compressed video and high-resolution snap shots with associated datestamps;
transmitting the compressed video and high-resolution snap shots to a remote location;
viewing the compressed video at the remote location and identifying an event at the location;
identifying datestamps associated with compressed video of the event;
viewing high-resolution snap shots associated with the identified datestamps;
analyzing the high-resolution snap shots associated with the identified datestamps by zooming in on areas of the high-resolution snap shots and identifying objects in the zoomed-in areas that are not identifiable in the compressed video of the event.

11. The method of claim 10, wherein the high-resolution snap shots are taken at a selectable frequency, further comprising setting the selectable frequency.

12. The method of claim 10, further comprising activating the first camera and second camera when motion sensors are triggered at the location.

13. The method of claim 10, further comprising connecting the viewing station with the processing device via a data network.

14. The method of claim 13, wherein the data network operates independently of any other networks.

15. The method of claim 10, further comprising controlling operation of the first and second camera via a local processing device.

16. The method of claim 15, further comprising powering the cameras and processing device with a portable battery system, for installation in areas without access to electric power.

17. The method of claim 16, further comprising recharging the portable battery system with with wind and/or solar power via recharge equipment.
